(19) United States
(12) Patent Application Publication
(10) Pub. No.: US 2010/0180121 A1
(43) Pub. Date: Jul. 15, 2010

(54) METHOD AND APPARATUS FOR ENHANCING SECURITY IN NETWORK-BASED DATA COMMUNICATION

(75) Inventors: Stanley Taihai Chow, Ottawa (CA); Kevin McNamee, Ottawa (CA)

Correspondence Address: FAY SHARPE/LUCENT, 1228 Euclid Avenue, 5th Floor, The Halle Building, Cleveland, OH, 44115-1843, US

(73) Assignee: ALCATEL-LUCENT, Paris (FR)

(21) Appl. No.: 12/351,193

(22) Filed: Jan. 9, 2009

(51) Int. Cl. H04L 9/32; G06F 21/00

(52) U.S. Cl. 713/175; 726/5

(57) ABSTRACT

Various embodiments of a method and associated equipment for enhancing security in a network-based data communication are provided. In one embodiment, the method includes: a) maintaining at least access to data which a transmitting user may selectively transmit, b) providing a submit control associated with a recipient user to which the data may be selectively transmitted, c) in response to the transmitting user activating the submit control, presenting information to the transmitting user that identifies the recipient user to which the data is about to be sent, and d) in response to the transmitting user activating a verification control, transmitting the data to the recipient user. In one embodiment, the associated equipment includes a first computing device associated with a transmitting user, a second computing device associated with a recipient user; and a communication network through which the first computing device can operatively communicate with the second computing device.

### BACKGROUND

The disclosures made herein relate to a method and apparatus for enhancing security in a network-based data communication. While the invention is particularly directed to the art of enhancing security of data communications in a communication network, and will be thus described with specific reference thereto, it will be appreciated that the invention may have usefulness in other fields and applications. For example, the invention may be used to verify or authenticate recipients prior to transmission of data to the corresponding recipient via a communication network.

In computing, phishing may include criminal activity whereby phishers (i.e. those engaged in phishing) attempt to fraudulently acquire sensitive information, such as usernames, passwords and credit card details, by masquerading as a trustworthy entity via an electronic communication. Online vendors, auction houses, financial transaction brokers, and banks that operate online are common targets for masquerading while a customer of the organization is the target of the phishing attack.

Phishing may be carried out, for example, by e-mail or IM messaging or typo squatting on e-mail addresses, IM addresses, or web site uniform resource locators (URLs) that ultimately request users to submit sensitive information to a fraudulent recipient. Among other data, a successful phishing attack could yield a user's social security number and personal information. Attempts to deal with the growing number of reported phishing incidents include legislation, user training, and technical measures.

In a phishing attack, the phisher may entice an unsuspecting victim to go a phishing site. For example you may receive a forged e-mail from a fraudulent party that appears to be from your bank and indicates your account has been suspended pending confirmation of certain information. The e-mail may give you a hypertext transfer protocol (HTTP) link to a web page which may instruct you to enter account numbers and passwords. Of course, your account was never suspended and the phisher, after receiving your information, may use it to deplete your account. Fundamentally, the problem is the user's verification (or authentication) of the receiver of the confidential information.

Secure socket layer (SSL) certificates do not solve this problem. An SSL certificate merely certifies that the certificate holder (e.g., the web site) is legally entitled to use a corresponding domain name, it says nothing about whether the domain name (i.e., the certificate holder) is for the user (i.e., the bank as opposed to the phisher) with which you actually wanted to communicate.

The domain name system (DNS) in combination with SSL/transport layer security (TLS) protocol, which is also known as HTTP security (HTTPS), can be used to confirm that web pages are coming from the actual owner of a corresponding URL. Unfortunately, several factors conspire to make HTTPS inadequate. One factor that makes HTTPS less effective is that many companies use multiple domain names and these domain names come and go with no consistent rules. For example, x-company may register “x-company” in all the important top level domains (e.g., x-company.com, x-company.net, x-company.org, etc.) and also in each country domain (e.g., x-company.ca, etc.). However, for a special promotion, x-company may have the x-company-TV.com domain name, but not the x-company-TV.ca domain name. This means consumers can be easily confused when presented with the domain names: x-companyTV.com, x-company-TV-special.com, etc.

Another factor that makes HTTPS less effective is that companies often have subsidiaries and other corporate entities and it is difficult for the average consumer to keep track of all these domain names. Still another factor that makes HTTPS less effective is that there are often multiple companies that legitimately have the same name. For example, two companies with the same name may legitimately operate in different jurisdictions. The DNS ownership model is essentially first come-first serve with a dispute resolution mechanism available to permit a party alleging superior rights to a given domain name to dispute the rights of a current owner. So, an unexpected entity may use a well-known domain name or a well-known company may use a domain name different from what one might expect. Still another factor that makes HTTPS less effective is that many numeric digits and/or text letters look alike. One classic approach for using numeric digits and text letters for deceitful purposes with respect to obtaining identity information is substituting the numeric digit zero (0) for the upper case letter “O” or numeric digit one (1) for lower case letter “l.” Moreover, there are much more sophisticated character substitution ruses, such as using Cyrillic characters or Unicode characters. This allows criminals to have fake domain names that may be indistinguishable from the real domain names at first glance. There is a whole class of software that tries to use a blacklist, as well as heuristics, to identify these fake domain names. However, this software adds to network overhead and it takes time to add rogue domains to the blacklist.

Recently, an authentication methodology referred to as extended validation (EV) certificate has been introduced. As the name implies, EV certificates have the same foundation as SSL/TLS certificates, but with extra validation which strengthens the binding of the certificate to the legal entity. However, EV certificates do not improve authentication that a given domain name is actually the one that was desired or expected. For additional information on EV certificates, see “Extended Validation certificates and XSS considered harmful,” Netcraft Ltd., Bath, England, United Kingdom, posted by Paul Mutton at 27 Feb. 2008, http://news.netcraft.com/archives/2008/02/27/extended_validation_certificates_and_xss_considered_harmful.html, the entire contents of which are fully incorporated herein by reference. It is believed that EV certificates only help catch a perpetrator after fraudulent activity (e.g., phishing) was perpetrated as opposed to preventing it from the start. For example, a perpetrator may gain access to a communication network through a shell entity with a network environment having little or no on-line fraud policing budget or interest in policing fraudulent or malicious on-line activities. Accordingly, EV certificates don't appear to solve the problem of phishing.

A phishwish filter may be used to examine e-mail to predict whether a given e-mail is likely to be a phishing e-mail. This is done by applying a series of heuristics to the body of the e-mail. For additional information on the phishwish filter, see Cook et al., “Phishwish: A Stateless Phishing Filter Using Minimal Rules,” 12^{th} International Conference on Financial Cryptography and Data Security, Jan. 28-31, 2008, Cozumel, Mexico, pp. 182-186, the entire contents of which are fully incorporated herein by reference. Phishwish has good discrimination because it is not signature-based. However, phishwish is only applicable to e-mails, while phishing may be initiated by phone calls, links from other sites, typos, etc., as well as e-mails. Additionally, some phishing e-mails will still get through phishwish because it relies on heuristics that may become less useful over time as the criminals adapt and develop countermeasures. Moreover, phishwish protection relies on deployment of the phishwish filter to every e-mail server. Any e-mail server that does not deploy the phishwish filter leaves its users exposed. Banks, for example, would prefer a more practical solution that does not require upgrading all e-mail servers. Generally, phishwish may reduce the volume of phishing e-mail, but it does not prevent phishing e-mail or reduce other phishing techniques.

Moreover, a Domain Name Server (DNS) flaw was discovered by IOActive researcher Dan Kaminsky in the first half of 2008. The flaw makes it possible for attackers to exploit the recursive nature of DNS server queries to “hijack” TCP/IP sessions and potentially redirect large segments of Internet traffic to unintended destinations. In July 2008, a security software patch added a port randomization factor to the transaction ID used to authenticate Internet sessions. This reduces the likelihood of session hijacking by many orders of magnitude for DNS servers that have deployed the patch. But the patch doesn't fix the DNS flaw—it only makes it more difficult for attackers to exploit it for phishing and other fraudulent activities. Experts are concerned that the next generation of attacks will attempt to compromise the patched systems, which would be much harder but is certainly possible, they say. There are major concerns over the potential of an attacker corrupting an email name server, essentially allowing him to redirect large amounts of email traffic.

Based on the foregoing, a solution that reduces phishing, regardless of whether the network-based communication approach is e-mail, web-based, or IM is desirable. Additionally, a solution that overcomes at least a portion of the drawbacks associated with known approaches for combating other network-enabled criminal and deceitful activity based on falsified or otherwise dishonest identity information is desirable.

### SUMMARY

In one aspect a method of enhancing security in a network-based data communication is provided. In one embodiment, the method includes: a) maintaining at least access to data which a transmitting user may selectively transmit, b) providing a submit control associated with a recipient user to which the data may be selectively transmitted, c) in response to the transmitting user activating the submit control, presenting information to the transmitting user that identifies the recipient user to which the data is about to be sent, and d) in response to the transmitting user activating a verification control, transmitting the data to the recipient user.

In another aspect, an apparatus for enhancing security in a network-based data communication is provided. In one embodiment, the apparatus includes: a first computing device associated with a transmitting user, a second computing device associated with a recipient user; and a communication network through which the first computing device can operatively communicate with the second computing device. In this embodiment, the first computing device includes: a submit control, a display device, and a verification control. The first computing device maintains at least access to data which the transmitting user may selectively transmit. The submit control is associated with the recipient user to which the data may be selectively transmitted. The display device displays information to the transmitting user that identifies the recipient user to which the data is about to be sent in response to the transmitting user activating the submit control. The first computing device transmits the data to the recipient user in response to the transmitting user activating the verification control.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a schematic diagram of an exemplary embodiment of a registration infrastructure and process that facilitates verification or authentication of a recipient user for a network-based data communication;

FIG. 2 is a schematic diagram of an exemplary embodiment of an information identity authentication infrastructure and process performed by a user device executing an exemplary embodiment of an identification information authentication application;

FIGS. 3a-c are schematic diagrams of an exemplary embodiment of a transmitting user device displaying exemplary embodiments of identification information authentication messages;

FIGS. 4a-d are schematic diagrams of exemplary embodiments of methods for recipient user authentication information to an exemplary embodiment of a transmitting user device;

FIG. 5 is a flow chart of an exemplary embodiment of a process for enhancing security in a network-based data communication;

FIG. 6, in combination with FIG. 5, is a flow chart of another exemplary embodiment of a process for enhancing security in a network-based data communication;

FIG. 7 is a block diagram of an exemplary embodiment of a communication network adapted to provide enhanced security in a network-based data communication;

FIG. 8 is a block diagram of an exemplary embodiment of a computing device adapted to provide enhanced security in a network-based data communication;

FIG. 9 is a flow chart of yet another exemplary embodiment of a process for enhancing security in a network-based data communication; and

FIG. 10, in combination with FIG. 9, is a flow chart of still yet another exemplary embodiment of a process for enhancing security in a network-based data communication.

### DETAILED DESCRIPTION

The present invention permits interested parties to offer recipient verification or authenticated identification information prior to actual transmission of data to the recipient to transmitting users having has access to data communication equipment programmed in accordance with the present invention. Examples of identification information include, but are not limited to, a name by which an entity is recognized, an image specific to an entity, text specific to an entity, and a sound specific to an entity. More specifically, examples of identification information include, but are not limited to, a protected name of an entity, a protected image of an entity, protected text of an entity, and protected sound of an entity. Protected is defined herein to include protection provided by a governing body means such as, for example, a trademark, a copyright, and other forms of registration of identification information and/or creating branded identification information (e.g., trademarks). Data communication equipment refers to computer and/or telephony equipment configured for communicating data over a telecommunication and/or computer network. Examples of such data communication equipment includes, but is not limited to, a computer configured for communicating via e-mail messages, a computer configured for communicating via Instant Messaging, a telephone configured for communicating via Instant Messaging, a computer configured for accessing web pages, a telephone configured for sending e-mail messages and a telephone configured for accessing web pages.

Data communication equipment programmed in accordance with the present invention includes one or more identification information registries (i.e., one or more RealName registries) and one or more information provider authentication applications. Each identification information registry is configured for storing unique identification information (e.g., name, text, image sound, etc) associated with information providers that wish to provide authentication of an information provider to transmitting users. An information provider refers to an entity that a transmitting user communicates with to receive and/or access information. Examples of information providers include, but are not limited to, senders of e-mail messages, senders of IM messages, web page owners and the like. Each information provider authentication application receives an authentication certificate associated with a data communication originated by an interested party and use the authentication certificate to facilitated authentication of identification information of the interested party. A notification is conveyed to the transmitting user(s) indicating whether the identification information has or has not been successfully authenticated.

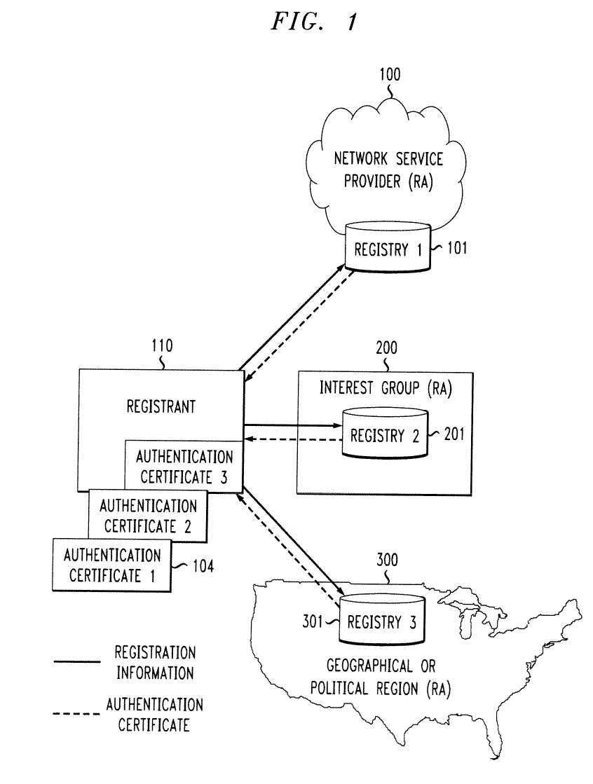

Referring now to the drawings wherein the showings are for purposes of illustrating the exemplary embodiments only and not for purposes of limiting the claimed subject matter, FIG. 1 provides a schematic diagram of an exemplary embodiment of a registration infrastructure and a process for registration of identification information that facilitates certain embodiments of the present invention. As shown generally in FIG. 1, a registrant 110 may register with three separate registries: registry 101 is operated by a registration authority (RA) that is a network service provider 100, registry 201 is operated by a RA that is an interest group (such as a trade association), and registry 301 is operated by a RA that is a geographical or political region (perhaps a government or other official entity). Registrant 110 may register in this manner to provide authenticated identification information to transmitting users that subscribe to any one of the available registries. That is, registrant 110 can be authenticated to a transmitting user if and only if the transmitting user subscribes to one or more of the available registries, in this example, registries 101, 201 or 301.

Each registry is operated by the respective RA. Operating a registry is defined herein to include maintaining information contained in a registry. A RA may be any public or private organization interested in providing an identification information registry. A RA does not require approval from any authority to operate, but may seek endorsement by these authorities. End-users, service suppliers, and/or equipment suppliers can determine if any given registry is trustworthy, and subscribe to only those registries determined to be trustworthy. Each registry is composed of two main parts—the RA (Certification Authority in X.509 parlance) and a database of identification information. Each registry serves a predetermined subscriber group, region and/or a predefined interest group. A region served by one registry may overlap a region served by another registry, and two or more registries may serve the same region. Similarly, two or more different defined interest groups can overlap (e.g., doctors and the more narrowly defined interest group of pediatricians).

The registry 101 is maintained by a network service provider 100 that wishes to provide an authenticated information provider service to any company, public or government organization, or other registrant 110 who wishes to provide authenticated identification information to transmitting users served by the network service provider 100. The registry 201 is operated by the interest group 200 such as, for example, the Canadian Bankers Association®, which maintains the registry 201 to provide authenticated identification information and/or associated services to its bank members. The registry 301 is associated with a geographical or political region such as, for example, New York State; the Province of Ontario; the City of Toronto; the greater Chicago area; etc. and is maintained by a corresponding government agency or other official entity 300.

In one embodiment, the only responsibility borne by the RAs 100, 200 or 300 is to ensure proof of identity of any registrant 110 and to ensure that it does not register any duplicate identification information for different registrants 110. In this embodiment, the registry 101 (which consists of the database and the RA) can be freely inspected by the public and it is at least partially the responsibility of registrants 110 and other interested parties to police the registries 101, 201 and 301 in order to ensure that a confusingly similar or misleading information provider identity is not registered by another registrant 110. When a registrant 110 is registered, the RA issues an authentication certificate 104. The authentication certificate certifies that the registered information provider identity (i.e., identification information) is bound to a public key of the registrant, which is in turn implicitly paired with a private key of the registrant.

The authentication certificate 104 provided to each registrant 110 by a registry can conform to any known authentication system, and each registry can use a different authentication system without departing from the scope of the present invention. When the registrant's identification information is recorded in a registry, an authentication certificate is provided to the registrant 110 to permit information provider authentication to be performed. The authentication certificate can be based on any public key infrastructure scheme like X.509.

If X.509 certificates are used for the authentication certificates provided to the registrants 110, in one embodiment of the present invention, the registration process proceeds as follows (i.e., using RA 100 as an example).

The RA 100 publishes its public key in its root certificate. The root certificate is a certificate that has the public key of the Registry (i.e., Certification) Authority). This public key is used to verify authentication certificates, so the root certificate must be imported into each device that will perform the information provider authentication. Typically, it is assumed a vendor or owner of data communication equipment will pre-load the root certificates of interest—including any local regional registries, all popular trade and professional registries, etc. in much the same way that Web browsers are preloaded with PKI root certificates today. Optionally, there is a way for allowing the end user to import more root certificates in the cases where the end user does business in multiple regions or is interested in a specialized registry. As understood by those skilled in the art, there is no limit to how many root public keys can be imported or the means for allowing such import.

Each interested party (i.e., registry applicant) wishing to become a registrant 110, generates its own public/private key pair, submits the public key to the RA 100 along with its identification information and any other required registration information and/or documentation.

If the RA 100 determines that the interested party in fact owns or is otherwise in lawful possession of the identification information, the RA 100 enters the identification information into the database 100 and uses the private key of RA 100 to sign an authentication certificate that includes the registrant's identification information and the registrant's public key. The RA 100 therefore “vouches” that the registrant's public key is “the” public key that is bound to the registrant's identification information, and that the registrant is entitled to use that identification information.

The registrant 110 now has a signed authentication certificate that attests to its identification information, and the registrant 110 also has the private key that permits the registrant 110 to validate that authentication certificate. It should be understood that the meaning of the authentication certificate is limited. The authentication certificate only signifies that the holder of the private key (which should be registrant 110) is entitled to have its identification information displayed in the jurisdiction of the particular registration authority 100 with which the registrant 110 has registered.

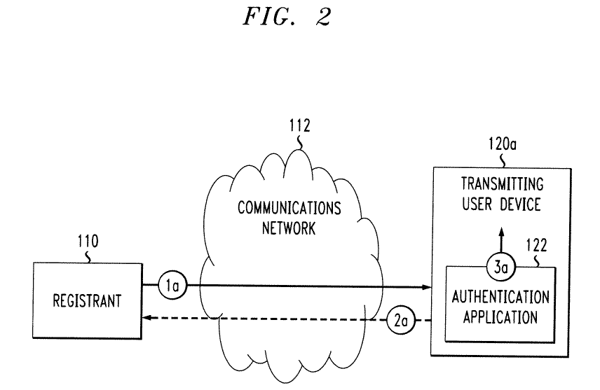

FIG. 2 shows an embodiment of an information provider authentication arrangement in accordance with the present invention. A transmitting user device (i.e., the device 120a) performs the information provider authentication. Examples of the device 120a include, but are not limited to, a device such as personal computer or an Internet Protocol (IP) telephone that is configured for communicating via e-mail messages, communicating via Instant Messaging and/or for accessing web pages. The device 120a is equipped with an information provider authentication application 122, which provides for a very secure form of information provider authentication in accordance with the present invention. This security stems from the transmitting user having direct control/oversight of the authentication application 122, meaning that the transmitting user only needs to trust its own device. In other embodiments, depending on the service (web/email/IM), it is possible to perform the authentication in a proxy. But, such an arrangement opens up many avenues of attack and makes it much more difficult to make secure. Accordingly, it can be seen that the device 120a being equipped with the information provider authentication application 122 advantageously provides for identification information authentication to be implemented in an “end-to-end” manner.

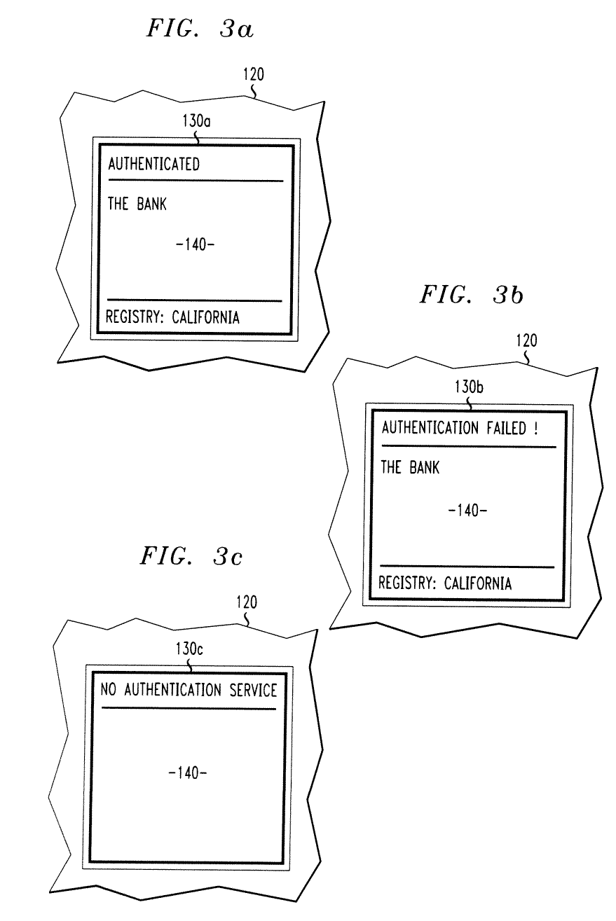

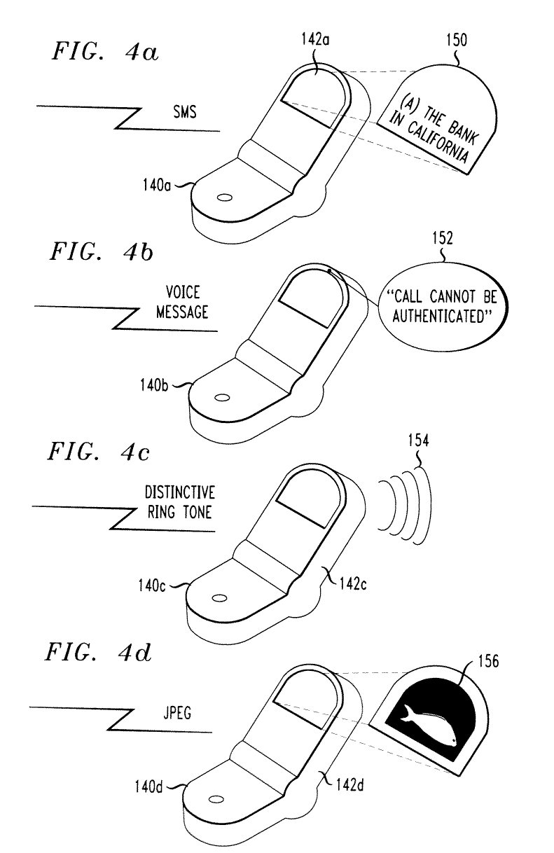

Still referring to FIG. 2, when the registrant 110 initiates transmission of offered information for reception by the device 120a, such information transmission (1a) proceeds through the data communication network(s) in a manner well known in the art. Examples of such information transmission include, but are not limited to, transmitting an e-mail message, transmitting an IM message, transmitting web site content, transmitting a web page, and other forms of transmitting information via a data communication or telecommunication network. In conjunction with transmitting the offered information, an information provider authentication interaction (2a) is initiated for causing registrant device 110 to send its authentication certificate for reception by the device 120a. In the case of the information being a web page, the interaction is dialog between the devices. In the cases of an e-mail or an IM message, the interaction includes the transmission of information, but may not be dialogue between the two devices as one or both end-point devices in an e-mail system or IM system may be offline. The offered information and the authentication certificate can be transmitted using the same or different ones of known communications protocol that are suitably configured for communicating data over a data network or communications network. In response to receiving the authentication certificate, the information provider authentication application 122 conducts the authentication interaction with the registrant device 110 and verifies authenticity of the authentication certificate obtained during the authentication interaction. It should be understood that information provider authentication does not require a query of the registries 101, 201, 301. It is disclosed herein that the registrant device 110 can be the same equipment used for facilitating transmission of the offered information or different equipment (e.g., the same server or a different server). Once determined, the result of the authentication process is then conveyed (3a) to the device 120a, as will be explained below with reference to FIGS. 3a-3c and 4a-4d.

An authentication application in accordance with the present invention preferably, but not necessarily, resides on a user device. This means that a user needs to trust only its device as opposed to remote devices. Depending on the service (e.g., web, email, IM, etc), it is possible to perform authentication in a proxy. But, this opens up many avenues of attack and makes the authentication process much more difficult to make secure. Accordingly, the “end-to-end” approach to authentication as disclosed herein is advantageous.

FIGS. 3a-3c show examples of information provider authentication messages conveyed to transmitting users in accordance with one embodiment of the present invention. In these examples, the information provider authentication messages that are displayed include information indicating whether the identification information has been successfully authenticated, information indicating the identification information (optionally the logo, etc.), and information designating which one of the registries 101, 201, 301 with which the information provider has registered.

FIG. 3a shows an exemplary display format 130a for identification information that has been successfully authenticated. A first line of the display format 130a indicates that the identification information has been successfully authenticated. The display format 130 is provided on a visual display 140 of the device 120. As depicted, the display format 130a encompasses a significant area of the visual display 140. However, in other embodiments (not shown), the display format 130a encompasses a limited area of the visual display 140. A second line of the display 130a displays the authenticated identification information. The last line of the display displays the name of the RA, in this example a registry associated with the State of California.

FIG. 3b shows an exemplary display format 130b for an information provider that could not be authenticated because authentication failed. As understood by those skilled in the art, information provider authentication may fail for any one of a number of reasons. For example, the information provider may present a stolen authentication certificate for which the information provider does not have the corresponding private key, the authentication certificate is from a registry that is not known to the user device, the authentication certificate cannot be validated with the public key of the CA, a communications failure may have occurred, an authentication interaction may have been interrupted, etc. A first line of the display 130b indicates that the information provider has not been successfully authenticated because information provider authentication has failed. A second line of the display 130b displays the identification information contained in the authentication certificate, if available. The last line of the display 130c displays the name of the registry contained in the authentication certificate, if available. To further highlight the fact that authentication failed, the message can be displayed in a bright color, red for example, etc.

FIG. 3c shows an exemplary display format 130c for an information provider that could not be authenticated because the information provider does not present an authentication certificate. The first line of the display 130c indicates that the information provider has not attempted authentication and the rest of the lines may be blank, as shown, or may display a identification information, in which case the fact that authentication was not attempted should be emphasized by highlighting or blinking the no authentication service message.

As will be understood by those skilled in the art, the display formats 130a-130c may not always be practical or desired by a transmitting user. For example, in the case of a personal computer, size of the visual display will typically not be a limiting factor with respect to visual presentation of the authentication results. However, size of a visual display of a handheld device such as a cellular telephone, personal digital assistant, handheld computer, etc may be a limiting factor in visual display of the authentication results. It is, therefore, contemplated that other forms of indicating authentication process results can be used for conveying such results. FIGS. 4a-4d illustrate alternate forms of indicating authentication process results for conveying such results to a transmitting user. Although the examples shown in FIGS. 4a-4d illustrate a specific type of device 140 (i.e., a cellular telephone), it should be understood that such other forms of indicating authentication process results can be conveyed to most known types of data communication devices.

As shown in FIG. 4a, in one embodiment, an information provider authentication or authentication failure can be conveyed via a transmitting user device using an out-of-band message outputted concurrently with or after a message receipt notification signal is outputted from the device 140a. In one embodiment, a visual message is outputted on a visual display 142a of the device 140a. In another embodiment, a Short Message Service (SMS) message is sent to the device 140a from a server that performs the authentication process and that SMS message is visually displayed on the visual display 142a. The visual message displayed includes an indication 150 that the information provider has been authenticated (A), shown in FIG. 4a, or not authenticated (NA), which is not shown, and the information provider ID (e.g., “The Bank in California”).

As shown in FIG. 4b, in another embodiment, an in-band audible message can be outputted via an audible output means of the device 140b when the transmitting user accesses corresponding offered information. The audible message indicates whether the information provider was or was not successfully authenticated. The audible message can be outputted after the transmitting user performs such accessing, but before the offered information is presented, so that the information provider cannot forge the audible message. In this embodiment, the transmitting user receives an audible message 152 indicating that the information provider could or could not be authenticated.

As shown in FIG. 4c, in another embodiment, a distinctive ring tone is outputted by an audible output means of the device 140c. One ring tone 154 indicates an authenticated information provider and another ring tone (not shown) indicates identification information could not be authenticated.

As shown in FIG. 4d, in yet another embodiment, an image 156 (e.g., a .jpeg image) is sent to the device 140d to indicate whether identification information has been authenticated. In this embodiment, the image 156 indicates that the identification information could not be authenticated by means of being an image that depicts a fraudulent/malicious activity (e.g., phishing) corresponding to the failed authentication. Another image (not shown) is used to indicate the situation in which identification information is successfully authenticated.

For additional information on registration infrastructures and utilization thereof for user authentication purposes in network-based communications, see U.S. Pat. App. Pub. No. 2008/0181379 to Chow et al., filed Jan. 30, 2007, U.S. Pat. App. Pub. No. 2008/0181380 to Gustave et al., filed Sep. 12, 2007, U.S. Pat. App. Pub. No. 2008/0187119 to Vinokurov et al., filed Feb. 6, 2007, U.S. patent application Ser. No. 11/811,235 to Chow et al., filed Jun. 6, 2007, and U.S. patent application Ser. No. 11/811,236 to Chow et al., filed Jun. 6, 2007. Each of these U.S. patent documents, as well as the present application, are assigned to Alcatel-Lucent, of Paris, France. The entire contents of all of these U.S. patent documents are fully incorporated herein by reference.

For example, a RealName registry is introduced in U.S. Pat. App. Pub. No. 2008/0181379 to Chow et al., filed Jan. 30, 2007, entitled “Caller Name Authentication to Prevent Caller Identity Spoofing” which disclosed a caller authentication scheme for telephone calls. The RealName registry functions as a certificate authority for names and be used to achieve several other useful functions that permit de-coupling of the “identification” function from DNS and other tools.

Domain names may be used for many functions—including load sharing, organization tracking, web-site hierarchy and so on. These functions have different requirements that make it difficult to handle the identification function as well. For identification, the registry infrastructure may resolve problems such as duplicate (and near duplicate) domain names. This solution can be implemented within jurisdictional boundaries. For example, trademark registries are a model that organizes names (i.e., trademarks, service marks, etc.) used in commerce. Each jurisdiction may have its own trademark registry, with possibly different rules for resolving ownership or a trademark, and different rules for determining whether a proposed name infringes an existing trademark. A RealName registry may be set up to operate like the trademark registries. In fact, the registry can be more decentralized—each jurisdiction can operate its own registry; each profession can operate its own registry; each trade association can operate its own registry; etc.

The user can pick and choose which registries to be used for authentication based, for example, on jurisdictions, professions, trade associations, etc. that are more related to typical user activities or with which the user is interested in dealing. Accordingly, this effectively permits screening of dealings with users associated with undesirable jurisdictions, professions, trade associations, etc. as well as only authenticating users associated with the selected registries. This arrangement of RealName registries may sidestep many problems. For example, undesirable legal disputes that plague the DNS system may be avoided, fake domain names that appear to be identical may be recognized, and certain ambiguous rules on ownership (e.g., does Dell, Inc. own the DellSucks.com site?) can be avoided.

For example, RealName registries may be implemented to facilitate verifying authenticity of the source of a web page for a user viewing the web page (e.g., see U.S. patent application Ser. No. 11/811,235 to Chow et al., filed Jun. 6, 2007). RealName registries may also be implemented to facilitate verifying authenticity of the source of an e-mail message for a recipient (e.g., see U.S. patent application Ser. No. 11/811,236 to Chow et al., filed Jun. 6, 2007). However, authentication of the source of a web page may be difficult because the HTML that defines the web page is not necessarily just not a single file.

In fact, most web pages are composed of many different pieces, such as images, frames, javascript, etc., each with a different URL. Verifying X.509 certificates for each piece may be time consuming or create high overhead; many web servers already off-load the operation to dedicated hardware to minimize the extra workload. Also, the pieces of a single web page may come from different servers. For example, many sites have advertisements that may be controlled by another company, such as Google.

Web servers may handle multiple domains. For example, it is common for www.company.com, www.company.net, www.company.ca to all be served from a single server. In theory, the server setup should separate the multiple domains but frequently, these servers treat everything as www.company.com. One consequence is that web sites may end up using the wrong SSL certificate for a given domain. Each SSL certificate is only valid for its corresponding unique domain. Many web sites need some sort of load balancing and replication for reliability. This means multiple machines (with possibly different OS and web server versions) may answer to the same URL. In the extreme cases, different pieces of a single pager, even just the pieces within a single domain, could come from different servers in the load balance set.

Many web pages are not static and may be generated dynamically. These dynamic pages may be generated by very complicated systems. It would not be practical to force each page to be modified to have special tags, etc. U.S. patent application Ser. No. 11/811,235 to Chow et al., filed Jun. 6, 2007) discloses the use of checksum mechanisms to facilitate verifying authenticity of the source of a web page. An “unforgable area” in the browser may be used to display the RealName which may rely on the user actually paying attention to the RealName. In XSS (Cross-Site Scripting), the attacker takes advantage of some feature/quirk/bug of a legitimate web site to make it look like the attack pages are legitimate.

Presented now is disclosure of facilitating verification or authentication in accordance with the present invention, as applied to a variety of specific types of communication mediums. Examples of these communication mediums include, but are not limited to e-mail, IM messages and web pages. Following are embodiments of specific approaches for independently facilitating recipient user verification or authentication in the context of a subsequent data transmission to the recipient user by a transmitting user from, for example, an e-mail, IM message, or a web page. A skilled person will appreciate that fraudulent and malicious activities are often perpetrated through combinations of communications mediums. For example, phishing activities often ‘present the bait’ through an e-mail message having falsified or confusing sender information and ‘set the hook’ through a web page that falsely purports to be that of a credible entity. Setting the hook often includes obtaining highly confidential information such as, for example, bank account information, thus allowing unauthorized withdrawal of funds from an account. Accordingly, it is disclosed herein that the approaches for facilitating recipient user authentication in accordance with the present invention and in the context of different communications mediums can advantageously be practiced independently or in combination for the purpose of combating fraudulent and/or malicious activities such as, for example, phishing over VoIP, business-to-business authentication, spam filtering, email forgery, web page forgery, web page phishing, IM session hacking and the like.

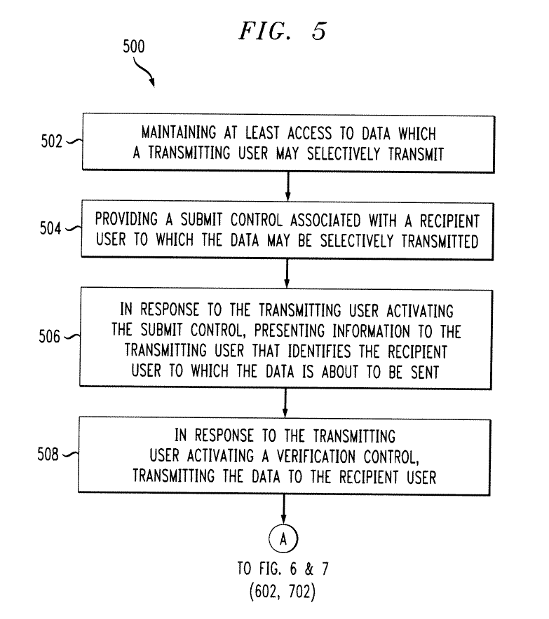

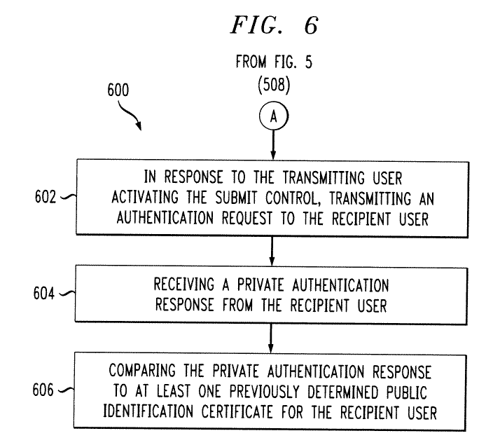

With reference to FIG. 5 an exemplary embodiment of a process 500 for enhancing security in a network-based data communication begins at 502 where at least access to data which a transmitting user may selectively transmit may be maintained. At 504, a submit control may be provided. The submit control may be associated with a recipient user to which the data may be selectively transmitted. Next, in response to the transmitting user activating the submit control, information may be presented to the transmitting user that identifies the recipient user to which the data is about to be sent (506). This may also include a ‘nounce’ that is part of the protocol that verifies the web site has a private key corresponding to the public key in the RealName certificate. At 508, in response to the transmitting user activating a verification control, the data may be transmitted to the recipient user.

In one embodiment, the data in 502 may be maintained in one or more text fields of a web page. The web page may also include the submit control. The default submit control may include the ‘action’ parameter of the ‘form’ tag in the HTML. Alternatively, the submit control may include an additional parameter specifically for this authentication. In another embodiment, the information presented to the transmitting user in 506 may include at least one of a domain name, a uniform resource locater (URL), and an internet protocol (IP) address associated with the recipient user. In still another embodiment, the information presented to the transmitting user in 506 may include a registered name associated with the recipient user. In yet another embodiment, the information presented to the transmitting user in 506 may be provided in a dialog box. The dialog box may include the verification control.

With reference to FIGS. 5 and 6, another exemplary embodiment of a process 600 for enhancing security in a network-based data communication includes 502 through 508 of FIG. 5. At 602, in response to the transmitting user activating the submit control, an authentication request may be transmitted to the recipient user. In one embodiment, the authentication request may include a list of fields identifying information to be sent, the URL to receiving the information, the URL of the page that caused the submission, and what other information needed to perform the authentication protocol (e.g., a ‘nounce’—essentially a random number that may be used in the cryptographic protocols). Next, a private authentication response may be received from the recipient user (604). In one embodiment, the private authentication response may include a RealName certificate, fields and other information from the authentication request, (if used) the nounce encrypted by the private key (that corresponds to the RealName certificate), and some means of assuring integrity of the messages (e.g., a signing the whole response). If the whole response message is signed by the private key, then that constitutes prove of possession of the private key; but may be too slow. A faster alternative is to just sign the nounce with the private key, then use some other MAC (Message Authentication Code) to ensure integrity. Note that a nounce is the simplest way to prevent a replay attack. At 606, the private authentication response may be checked by validating the RealName certificate, that the RealName certificate is bound to the ‘expected’ entity (e.g., the correct bank register in the correct registry), that the recipient user has demonstrated possession of the private key, and that the message has not been tampered with. For an embodiment using a nounce with X.509, for example, validating a certificate means checking that the RealName certificate is correctly signed by the registry, that the certificate has not expired or been revoked, etc. The protected name (or image) in the RealName certificate can be presented to the user for confirmation that it is the expected entity (or the user could have pre-selected the expected entity). Possession of the private key is proved by encrypting the nounce with the private key, then the transmitting user decrypts with the public key in the RealName certificate; many other protocols are possible, this is merely the simplest. When the private authentication response passes all four tests (e.g., validating, correct name, private key, message integrity), we can assume that the owner of the RealName certificate has certified that it is taking responsibility for the transmitting user to send that information to that URL. Note that this is a positive acknowledge from the expected entity, which could be logged as proof of transmission.

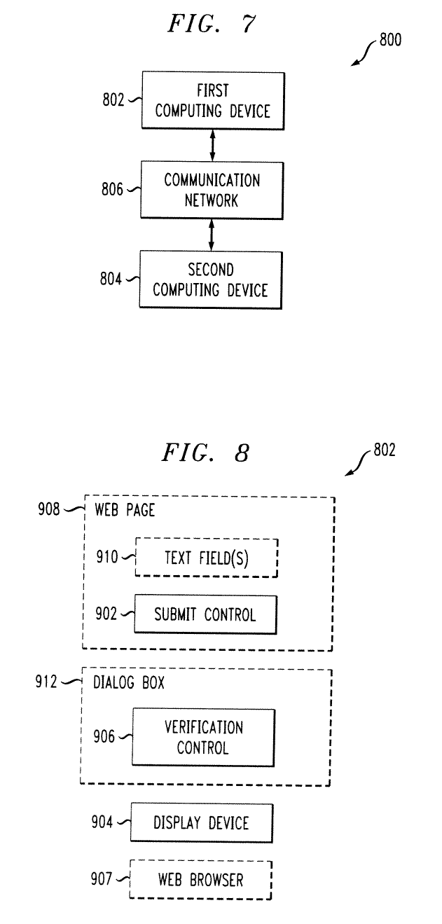

With reference to FIG. 7, an exemplary embodiment of a hybrid network 800 adapted to provide enhanced security in a network-based data communication may include a first computing device 802 associated with a transmitting user, a second computing device 804 associated with a recipient user, and a communication network 806 through which the first computing device can operatively communicate with the second computing device. The first and second computing devices 802, 804 may include any suitable type of computing device, including desktop, laptop, or other types of personal computers; file servers or other types of network appliances; landline, mobile, satellite, and other types of telephones; and broadcast, cable, satellite, and other types of televisions. The communication network 806 may include any suitable communication network, including the a wired or wireless local area network (LANs), a landline or cellular telephone network, a satellite telephone, television, or data communication network, a cable television network, and other types of communication networks. Of course, the communication network 806 may include any suitable combination of various communication networks, gateways between networks, and other types of suitable interfaces between communication networks. For example, the Internet is a hybrid communication network that includes any computing device and communication network that is capable of accessing the Internet.

With reference to FIGS. 7 and 8, the first computing device 802 may include a submit control 902, a display device 904, and a verification control 906. The first computing device 802 may maintain at least access to data which the transmitting user may selectively transmit. The submit control 902 may be associated with the recipient user to which the data may be selectively transmitted. The display device 904 may display information to the transmitting user that identifies the recipient user to which the data is about to be sent in response to the transmitting user activating the submit control 902. The first computing device 802 may transmit the data to the recipient user in response to the transmitting user activating the verification control 906.

In one embodiment, the first computing device 802 may include a web browser 907 which may display a web page 908 on the display device 904. The web page 908 may maintain the data to be transmitted to the recipient user in one or more text fields 910. In this embodiment, the web page 908 may include the submit control 902. For example, the submit control 902 may be linked to a URL for the recipient user via HTML commands that define the web page 908.

In another embodiment, the first computing device 802 may transmit a first authentication request associated with the recipient user to the second computing device 804 in response to the transmitting user activating the submit control 902. The first computing device 802 may receive a private authentication response associated with the recipient user from the second computing device 804. The first computing device 802 may check the private authentication response as described above. In this embodiment, the private authentication response may include at least one of a RealName, a checksum, a trade name, a trademark, a logo, an image, an audio recording, a video recording, and text information associated with the recipient user. In still another embodiment, the information identifying the recipient user may be provided in a dialog box 912. The dialog box 912 may also include the verification control 906.

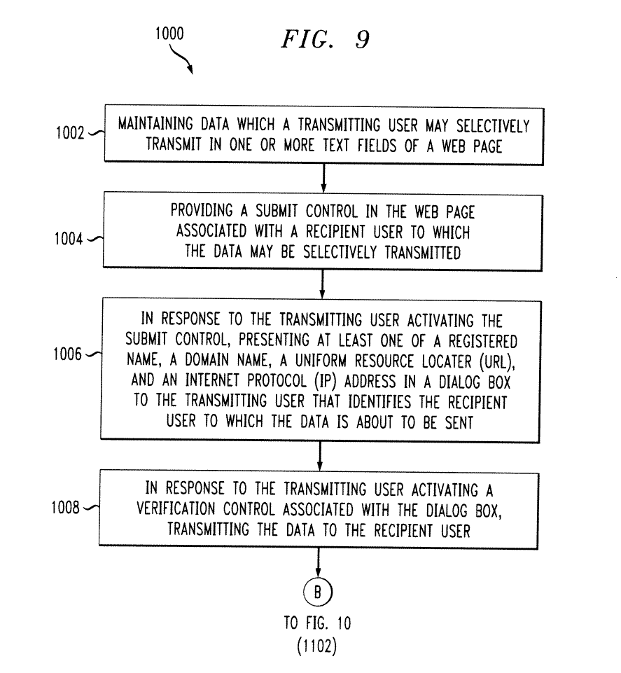

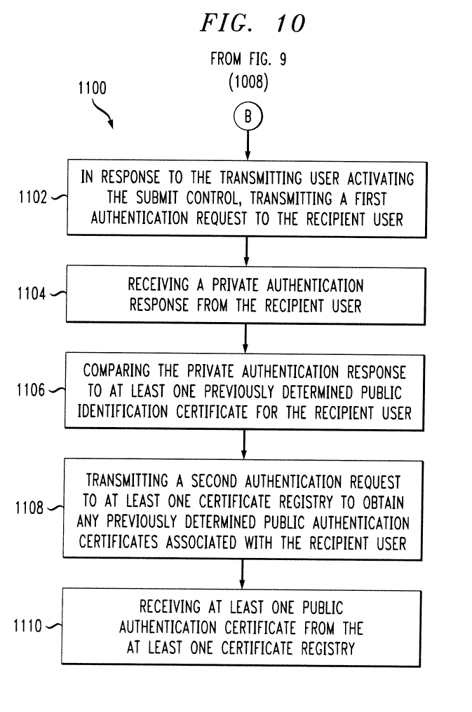

With reference to FIG. 9, yet another exemplary embodiment of a process 1000 for enhancing security in a network-based data communication begins at 1002 where data which a transmitting user may selectively transmit in one or more text fields of a web page may be maintained. At 1004, a submit control may be provided in the web page associated with a recipient user to which the data may be selectively transmitted. For example, the submit control may be linked to a URL for the recipient user via HTML commands that define the web page. Next, in response to the transmitting user activating the submit control, at least one of a registered name, a domain name, a uniform resource locater (URL), and an internet protocol (IP) address may be presented in a dialog box to the transmitting user that identifies the recipient user to which the data is about to be sent (1006). At 1008, in response to the transmitting user activating a verification control associated with the dialog box, the data may be transmitted to the recipient user.

With reference to FIGS. 9 and 10, still yet another exemplary embodiment of a process 1100 for enhancing security in a network-based data communication includes 1002 through 1008 of FIG. 9. At 1102, in response to the transmitting user activating the submit control, a first authentication request may be transmitted to the recipient user. Next, a private authentication response may be received from the recipient user (1104). At 1106, the private authentication response may be checked as described above. In this embodiment, the information presented to the transmitting user in 1006 may be based at least in part on the comparing in 1106. In one embodiment, the private authentication response may include at least one of a RealName certificate, a checksum, a trade name, a trademark, a logo, an image, an audio recording, a video recording, and text information associated with the recipient user.

In several embodiments disclosed herein, an exemplary embodiment of a registration infrastructure with a RealName directory and at least one certificate authority may be implemented to facilitate verification of the authenticity of a recipient user at the time of the submit. That is, between the time a transmitting user activates a submit control and the actual transmission of data to the recipient user. This simplifies the protocol for verifying the authenticity of a user over that used in conjunction with authenticating the source of an e-mail, IM message, or web page.

Also, this solution does not rely on the user checking the status or results of authentication prior to transmitting data to another user. Indeed, the user does not need to know anything check anything. After the user has activated the submit control, the browser may inform the user where the information is going or provide other related information to the user and wait for the user to confirm the submission prior to actually transmitting the data. This protocol is upward compatible and each web site need only support a query. There is no impediment to deployments.

Each registry may operate as an issuer of a “certificate of approved name” as well as a database of “approved” names (e.g., these names may be referred to as RealNames). The certificates can be accomplished in many ways. For example, X.509 certificates that are used for existing DNS/SSL may be used. In X.509 parlance, each registry may operate as the “certificate authority” and each certificate may essentially be a package embedding the RealName and a public key. This package may then be signed by a private key of from the certificate authority. In operation, the certificates may contain logos and other audio-visual material as well as names to help reinforce the identity of the company.

Browsers may be pre-loaded with the “local” registries. Since one goal is to prevent phishing, care is taken to protect information entered by the user. Authenticating the HTML is one way to achieve that goal. However, phishing can also be prevented by authenticating the receiving web site with respect to the information entered by the user. This means authenticating the “submit URL”—that is, the URL that the browser will use to send information (typically specified in the HTML as the “action” parameter of a “form”). For example, the submit URL may look like: http://domain.com/cgi-bin/form1.pl where “http” is the protocol to use, “domain.com” is the domain name, and “/cgi.bin/form1.pl” is the path (that identifies the particular form that is being submitted).

Authentication of the “submit URL” can be performed in several ways. For example, in one embodiment, a standardized checking URL may be used to check the submit URL. The checking URL may be constructed by gluing a standard path on the protocol and domain of the submit URL. For example, a standardized checking URL may look something like http://domain.com/CheckRealName. The submit URL may be sent as a parameter with the standardized checking URL. In another embodiment, a standardized parameter may sent along with the submit URL. The standardized parameter would request that the recipient user authenticate the submit URL. In other embodiments, the HTML form may include an extension that specifies whether the checking URL embodiment or standardized parameter embodiment are being used. Further embodiments, may use a non-standard checking URL or non-standard parameters.

In general, the goal is to ask the receiving web site to authenticate the submit URL. This can be done in any number of ways. For example, in one embodiment, the browser may send a nonce (i.e., a random number that is used only once) along with the submit URL. The web site may encrypt the nonce and the submit URL and send it back along with its RealName certificate. The browser may decrypt the nonce using a public key for the RealName certificate obtained from one or more registry.

If the RealName certificate is validated in the usual X.509 manner, and the web site correctly authenticates (e.g., by encrypting the nonce using the private key), then the browser may consider the authentication complete and successful. Otherwise, the authentication fails. The browser may pop up a dialog box telling the user the result and ask the user to confirm submission for successful authentication or to authorize submission despite failed authentication. Confirmation of successful authentication may also give the user the opportunity to verify that the authentication information does indeed identify the company to which submission is intended.

After the submit URL is confirmed (or ignored by the user), the browser can send the data to the recipient user in any suitable manner. Optionally, the data can be encrypted with the public key of the web site (i.e., in conjunction with the authenticated RealName certificate) instead of using HTTPS/SSL for every page. Otherwise, use of HTTPS/SSL may impose a significant encryption work load on the web server and browser.

In general, the various embodiments of methods and apparatus disclosed herein make use of a single infrastructure to solve the web phishing problem in a way that is quite practical for web sites and browsers to implement. At the same, it does not require special user training, does not inconvenience the user, and may reduce user errors.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of enhancing security in a network-based data communication, the method including:
a) maintaining at least access to data which a transmitting user may selectively transmit;
b) providing a submit control associated with a recipient user to which the data may be selectively transmitted;
c) in response to the transmitting user activating the submit control, presenting information to the transmitting user that identifies the recipient user to which the data is about to be sent; and
d) in response to the transmitting user activating a verification control, transmitting the data to the recipient user.

2. The method of claim 1, further including:
e) maintaining the data in one or more text fields of a web page, the web page also including the submit control.

3. The method of claim 1, further including:
e) presenting at least one of a domain name, a uniform resource locater (URL), and an internet protocol (IP) address associated with the recipient user to the transmitting user.

4. The method of claim 1, further including:
e) presenting a registered name associated with the recipient user to the transmitting user.

5. The method of claim 1, further including:
e) presenting a dialog box to the transmitting user, the dialog box including the information identifying the recipient user and the verification control.

6. The method of claim 1, further including:
e) in response to the transmitting user activating the submit control, transmitting an authentication request to the recipient user;
f) receiving a private authentication response from the recipient user; and
g) comparing the private authentication response to at least one previously determined public identification certificate for the recipient user;
wherein the information presented to the transmitting user in c) is based at least in part on the comparing in g).

7. The method of claim 6 wherein the private authentication response includes at least one of a private key, a RealName, a checksum, a trade name, a trademark, a logo, an image, an audio recording, a video recording, and text information associated with the recipient user.

8. The method of claim 1, further including:
e) in response to the transmitting user activating the submit control, transmitting an authentication request to at least one certificate registry to obtain any previously determined public authentication certificates associated with the recipient user; and
f) receiving at least one public authentication certificate from the at least one certificate registry;
wherein the information presented to the transmitting user in c) is based at least in part on the at least one public authentication certificate.

9. The method of claim 8 wherein each public authentication certificate includes at least one of a public key, a RealName, a checksum, a trade name, a trademark, a logo, an image, an audio recording, a video recording, and text information associated with the recipient user.

10. An apparatus for enhancing security in a network-based data communication, the apparatus including:
a first computing device associated with a transmitting user, the first computing device including a submit control, a display device, and a verification control;
a second computing device associated with a recipient user; and
a communication network through which the first computing device can operatively communicate with the second computing device;
wherein the first computing device maintains at least access to data which the transmitting user may selectively transmit, the submit control is associated with the recipient user to which the data may be selectively transmitted, the display device displays information to the transmitting user that identifies the recipient user to which the data is about to be sent in response to the transmitting user activating the submit control, and the first computing device transmits the data to the recipient user in response to the transmitting user activating the verification control.

11. The apparatus of claim 10, the first computing device further including:
a web browser displaying a web page on the display device, the web page maintaining the data in one or more text fields and including the submit control.

12. The apparatus of claim 10 wherein the first computing device transmits a first authentication request associated with the recipient user to the second computing device in response to the transmitting user activating the submit control, receives a private authentication response associated with the recipient user from the second computing device, and compares the private authentication response to at least one previously determined public identification certificate for the recipient user, the information displayed on the display device identifying the recipient user being based at least in part on the comparing.

13. The apparatus of claim 12 wherein the private authentication response includes at least one of a private key, a RealName, a checksum, a trade name, a trademark, a logo, an image, an audio recording, a video recording, and text information associated with the recipient user.

14. The apparatus of claim 12, further including:
at least one certificate registry, each certificate registry in operative communication with the first and second computing devices via the communication network;
wherein the first computing device transmits an authentication request to at least one certificate registry to obtain any previously determined public authentication certificates associated with the recipient user and receives at least one public authentication certificate from the at least one certificate registry.

15. The apparatus of claim 14 wherein each public authentication certificate includes at least one of a public key, a RealName, a checksum, a trade name, a trademark, a logo, an image, an audio recording, a video recording, and text information associated with the recipient user.

16. A method of enhancing security in a network-based data communication, the method including:
a) maintaining data which a transmitting user may selectively transmit in one or more text fields of a web page;
b) providing a submit control in the web page associated with a recipient user to which the data may be selectively transmitted;
c) in response to the transmitting user activating the submit control, presenting at least one of a registered name, a domain name, a uniform resource locater (URL), and an internet protocol (IP) address in a dialog box to the transmitting user that identifies the recipient user to which the data is about to be sent; and
d) in response to the transmitting user activating a verification control associated with the dialog box, transmitting the data to the recipient user.

17. The method of claim 16, further including:
e) in response to the transmitting user activating the submit control, transmitting a first authentication request to the recipient user;
f) receiving a private authentication response from the recipient user; and
g) comparing the private authentication response to at least one previously determined public identification certificate for the recipient user;
wherein the information presented to the transmitting user in c) is based at least in part on the comparing in g).

18. The method of claim 17 wherein the private authentication response includes at least one of a private key, a RealName, a checksum, a trade name, a trademark, a logo, an image, an audio recording, a video recording, and text information associated with the recipient user.

19. The method of claim 17, further including:
h) transmitting a second authentication request to at least one certificate registry to obtain any previously determined public authentication certificates associated with the recipient user; and
i) receiving at least one public authentication certificate from the at least one certificate registry.

20. The method of claim 19 wherein each public authentication certificate includes at least one of a public key, a RealName, a checksum, a trade name, a trademark, a logo, an image, an audio recording, a video recording, and text information associated with the recipient user.
